(19) United States
(12) Patent Application Publication
(10) Pub. No.: US 2025/0317278 A1
(43) Pub. Date: Oct. 9, 2025

(54) SYSTEM AND METHOD FOR A BACK UP NFC HARDWARE WALLET

(71) Applicants: Zachary Herbert, Boston, MA (US); Kenneth Carpenter, Carlsbad, CA (US)

(72) Inventors: Zachary Herbert, Boston, MA (US); Kenneth Carpenter, Carlsbad, CA (US)

(21) Appl. No.: 18/974,435

(22) Filed: Dec. 9, 2024

Related U.S. Application Data
(60) Provisional application No. 63/610,400, filed on Dec. 14, 2023.

(51) Int. Cl. H04L 9/08; G06Q 40/02

(52) U.S. Cl. CPC H04L 9/085; G06Q 40/02; H04L 9/0863

(57) ABSTRACT

A backup system and method for splitting a master key on a hardware wallet into different shares by way of Shamir Secret Sharing using architecture that utilizes near field communication protocols for split shares. A hardware wallet apparatus writes and optionally encrypts data split on to tags, such as a card or wearable employing near field communication devices and enables a user access to their cryptocurrency funds without the need of a lengthy private key. A split of the shares is also stored on a companion mobile application. Restoration of lost data can be acquired with ease by way of the system's Foundation server and seed hash, without attaining personal user data.

### CROSS REFERENCE TO RELATED APPLICATIONS

This application claims the benefit of U.S. Provisional Patent Application Ser. No. 63/610,400, filed Dec. 14, 2023, the contents of which are incorporated herein by reference.

### BACKGROUND OF THE INVENTION

A hardware wallet is a wallet designed primarily to store private keys for cryptocurrency management. In some instances, these also include various cryptographic assets, such as non-fungible tokens. Securing cryptographic wallets has become imperative as their use is on the rise.

The current industry standard for securing hardware wallets includes using seed words, which allow private keys to be rendered as a number of words (typically 12 or 24 words), which can be recited on a piece of paper, stamped in metal, stored, or input into a password manager. This method is employed when conducting the initial steps in setting up a hardware wallet by way of a private key displayed in the form of “seed words.” The user can record these words, and the wallet is backed up. To restore the backup, the user has to enter the seed words into their new hardware wallet or software wallet and regain access to their funds.

While this method is perpetual when stored correctly, easily accessible because it is entirely offline, and cross-compatible because it is the industry standard, there are some security concerns regarding this approach. For example, someone can take all the funds in the user's account if anyone finds a user's seed words. Or, if the user loses their seed words, they can no longer access their funds. Moreover, various schemes make it possible to disclose their seed words to malicious phishing scams. Of course, there is also the burden of having to write and re-address the seed words when a user wishes to restore access to their funds on a new hardware wallet, which can be unnecessarily arduous in an era where facial recognition and four-letter PINs alone can grant one access to nearly any digitized application. Moreover, restoring a wallet is a hassle; the setup does not save previous settings, so a user must re-input all their former settings in order for their wallet to operate as previously configured.

Another approach entails encrypting a backup, usually on a microSD or other removable media, a file containing the seed words, device settings, multi-sig configurations, account labels, and more. The files are stored as a .txt file and encrypted as a .7z archive. The wallet generates an alphanumeric code and provides it to the user, and to restore the backup, the user must insert the microSD Card into a Passport and enter the 20-digit code. Unlike the former, this approach enables users to maintain their previous settings, and it is faster than inputting the seed words. The method is also more secure as the 20-digit code alone won't grant anyone access, as they need the coupling of the 20-digit code and the microSD. Still, there are limitations to this approach. The microSD flash hardware is not designed to last more than approximately ten years and has a no-fault tolerance. If one loses the backup code or the microSD, they risk losing all their assets.

As a result, there is a much-needed gap to fill in the realm of securing hardware wallets. Whereas previous approaches have required a physical component coupled with private keys or just a lengthy series of words that need to be written down and stored securely in order to avoid losing all one's funds, the present invention offers a solution by way of a refined system architecture, which features NFC tags that can be in a card form factor, a tag, a ring, or various wearables; a mobile application and a Foundation server in combination come to provide a backup method that splits the master key on the hardware wallet into different shares that are automatically secured, encrypted, backed up, while also allowing room for users to recover their accounts, settings and funds without having to worry about the concerns as mentioned above of previous industry standards.

### SUMMARY OF INVENTION

The present invention pertains to a system and method for Near Field Communication (NFC) tags, which manifest in card form factor, a tag, a ring, or other variations of wearables that operate via a mobile or desktop application and collaborate with a Foundation server to store encrypted backups. NFC tags are short-range wireless communication technologies that allow data exchanges across various devices over a short, proximal distance. These devices can store and transmit data between devices that enable such connections as a smartphone or electronic device programmed to receive such instructions. An NFC tag typically employs a microchip and an antenna and can process several commands and deploy wireless communications and connections between two devices. This type of tag or technology is used in contactless payments. It is compatible with most smart technology, such as smartphones, so the gravitation towards this approach has become favorable.

However, the tag alone cannot remedy the issues of maintaining records of keys to hardware wallets. The architecture of the present invention relies on splitting a master key on the hardware wallet into different “shares” using Shamir Secret Sharing (SSS) through an innovative architecture, the default embodiment of which is a 2-of-3 method that may be expanded upon or customized. For example, future embodiments may require different fractions and variations of those methods, such as a 1-of-3 or another alternative split of shares.

One iteration of Passport, for reference, is a secure, encrypted apparatus that will be utilized as a hardware wallet. The instrument can use a camera and quick-response (QR) codes for communication, and can also have NFC capabilities. Passport supports Bitcoin via partially signed Bitcoin transactions. It supports various software wallets, by way of example and not limitation, Bitcoin Core, BlueWallet, BTCPay, Casa, Electrum, Nunchuk, Simple Bitcoin Wallet, Sparrow, Specter, Wasabi, and other wallets supporting PSBTs via microSD or QR codes. The system utilizes an STM processor, Microchip ATECC608B secure element, and an OmniVision Cameracube. The device uses a user-removable 1200 mAh Lithium-ion battery in the Nokia BL-5C form factor to power the device. Some of the air-gapped device's security features include easy passphrase entry, security lights, anti-phishing words, and security validation. The primary iteration, which is the most compatible for the present invention's ecosystem, is a touch screen device with a processor, secure element, wireless Bluetooth and NFC devices, and USB communications.

In one embodiment of the present invention, two shares are stored on the NFC cards. While setting up the hardware wallet, Passport, the user simply taps the NFC card to the Passport, and the Passport will copy a share to the NFC cards. It should be noted that the hardware wallet device also has a companion mobile application, Envoy. This application can store any kind of data. Passport uses SSS to make shares that can be reconstituted into the data if the threshold is met. timestamps of each interaction, the number of shares, the number of unique IDs, and all interactions of the NFC tags with the device. The original data and the Shamir shares are encrypted to enhance the levels of protection, to ensure protection and security.

Further, one share is stored on the user's mobile companion application. The companion application automatically backs up information onto a third party cloud provider, such as iCloud or Google, and the Foundation Server. An encrypted backup file is created habitually on Passport as a .txt file and encrypted by a seed hash as a .7z file. The backup is automatically sent through the companion app and stored on the Foundation server. The server uses a hash of the seed in place of a username, so discretion and privacy are at the forefront of the operation, and no personal data needs to be collected from the user's end.

Recovery of a user's funds, accounts, and data is seamless. A user just takes a new Passport and connects it to the companion application, Envoy, via Bluetooth; this automatically restores the first share of their NFC master key. The user taps one of the NFC cards or tags to Passport, and if the user loses access to the companion application, they can tap both the NFC cards and tags to Passport instead. The hash of the seed is shared with the companion application and it downloads and sends the encrypted backup from the Foundation Server to Passport, which uses the seed to decrypt the backup file locally, and then all funds and data are restored on Passport.

Another embodiment of the present system's architecture includes re-encrypting the NFC cards in another fashion. For example, a PIN or a password may be required to access data from the card as an added layer of protection. Or more NFC cards could be added to the setup; instead of a 2-of-3 setup, a 3-of-5 setup with 4 NFC cards or tags and one share can be stored on the companion application (and backed up to the cloud). It should be noted that NFC cards are used by way of reference and that near-field communication devices can be employed on any piece or wearable that a user may deem compatible or fit for their operations, such as a ring, watch, bracelet, necklace, key fob, phone case, or other physical, tangible object that they want to adhere the tag technology to. A benefit of using near-field communication tags is that they are meant to last longer than microSD cards, as they are designed to retain data for 50 years, and that they're much more fault tolerant compared to other versions of data storage for hardware wallets as the present invention's architecture allows for improved accessibility and recovery of funds.

Other implementations include RFID technology that can be paired with the NFC cards or tags in order to track where they are. This can help a user find their NFC card while accessing only limited sections of the companion app.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 depicts the near field communication protocols, which may be implemented by a card or a ring in connection with the electronic communication device and the Passport device.

FIG. 2 depicts the architecture of the present system which operates using the Shamir Secret Sharing (SSS) system, near field communication protocols and a Passport device.

FIG. 3 is a shell diagram showcasing each component of each technological element in the present invention.

FIG. 4 is an illustration depicting an exemplary operating environment including one or more user computers, computing devices, or processing devices, which can be used to operate a client, such as a dedicated application, web browser is shown.

FIG. 5 is another illustration depicting an exemplary operating environment including a computer system with various elements as shown.

While various embodiments of the disclosed technology have been described above, it should be understood that they have been presented by way of example only and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and designs. Indeed, it will be apparent to one of skill in the art how alternative functional, logical, or physical partitioning and configurations may be implemented to implement the desired features of the technology disclosed herein. Also, a multitude of different constituent module names other than those depicted herein may be applied to the various partitions. Additionally, with regard to flow diagrams, operational descriptions, and method claims, the order in which the steps are presented herein shall not mandate that various embodiments be implemented to perform the recited functionality in the same order unless the context dictates otherwise.

### DETAILED DESCRIPTION OF THE PREFERRED EMBODIMENT

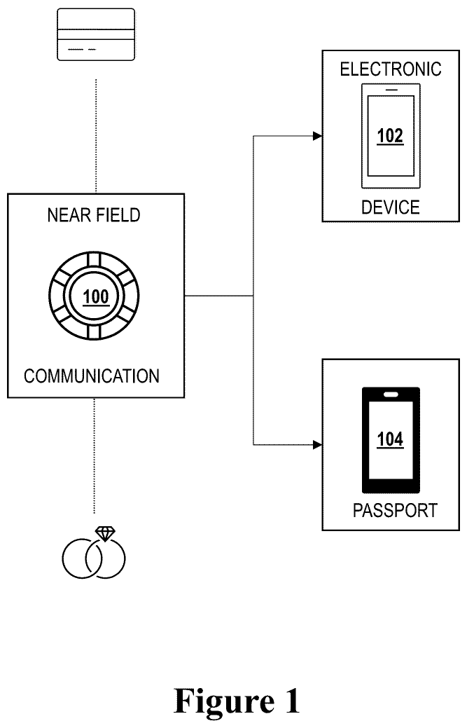

FIG. 1 depicts the near field communication (NFC) protocols, which may be implemented by a card or a ring in connection with the electronic communication device and the Passport device. The NFC 200 (relationship represented by the dotted line) can be either a ring, bracelet, necklace or other piece of jewelry or element in connection with the chip NFC 200 or a card. The NFC 200 may be connected to the electronic device 102 when in proximity to the device and the companion application for the Passport 104 is activated. The Passport 104 is a secure, encrypted apparatus that will be utilized as a hardware wallet. The instrument supports USB and wireless communications, in addition to a camera for QR codes and scanning. The device supports various software wallets, by way of example and not limitation, Bitcoin Core, Blue Wallet, BTCPay, Casa, Electrum, Nunchuk, Simple Bitcoin Wallet, Sparrow, Specter, Wasabi, and other wallets supporting PSBTs via microSD or QR codes. The system may, by way of example and not limitation, utilize an STM processor, Microchip 608b secure element, and an OmniVision cameracube. The device uses a user-removable 1200 mAh Lithium-ion battery in the Nokia BL-5C form factor to power the device. The device also has a touchscreen iteration, with a graphical user interface.

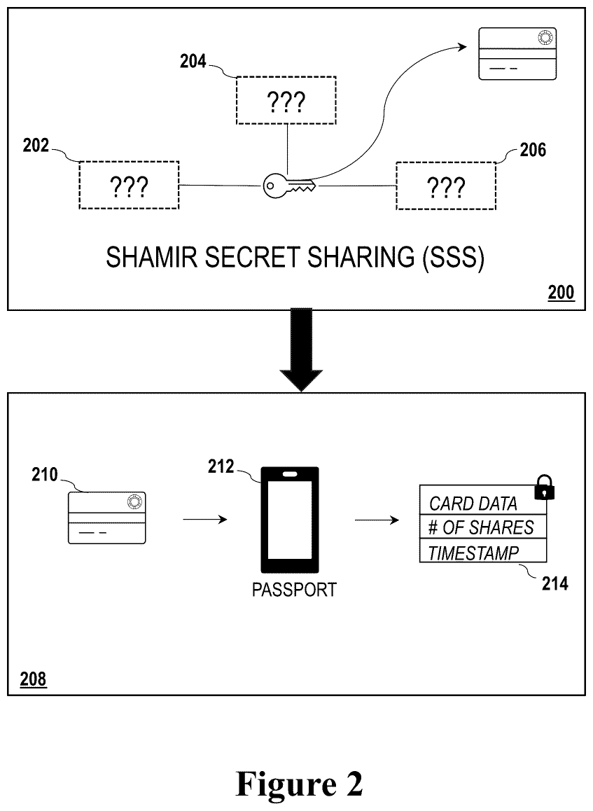

FIG. 2 depicts the architecture of the present system which operates using the Shamir Secret Sharing (SSS) system, near field communication protocols and a Passport device. The Shamir Secret Sharing System 200 typically will employ a 2-of-3 method that may be expanded upon or customized. In some embodiments different variations of those methods, such as a 1-of-3 or another alternative split of shares are employed based on the desires and discretion of an end user. For the purpose of the present figure, three shares are depicted. FIG. 2 shows share one 202, share two 204, share three 206 which may be associated with the NFC card or piece 210. The associated NFC card or piece 210 is then tapped on to the Passport device 212 and a ledger containing the card data is shown, such as the number of shares, the number of unique IDs, and all interactions of the NFC card or piece 210 with the device.

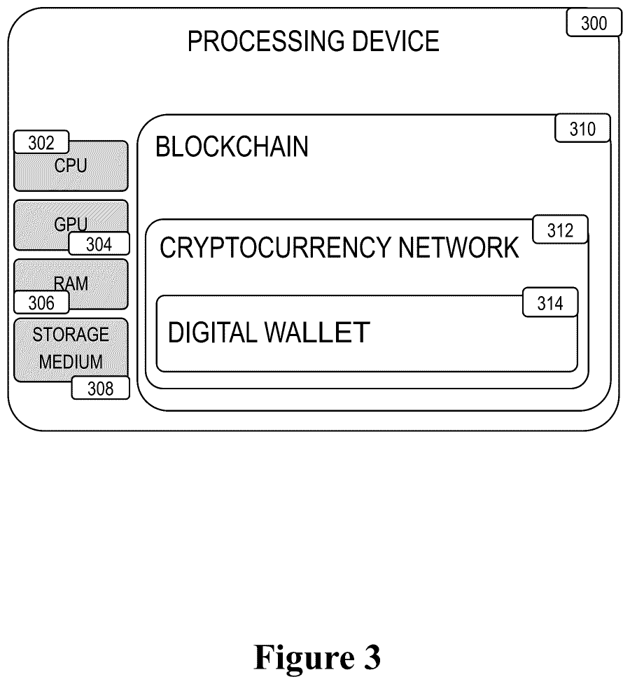

FIG. 3 is a shell diagram showcasing each component of each technological element in the present invention. A processing device 300 is the setting for the blockchain 310, cryptocurrency network 312 and digital wallet 314 which has public and private keys for transactions. The processing device has a central processing unit 302, a graphics processing unit 304, random access memory 306, and a storage medium 308 which may be transitory or non-transitory.

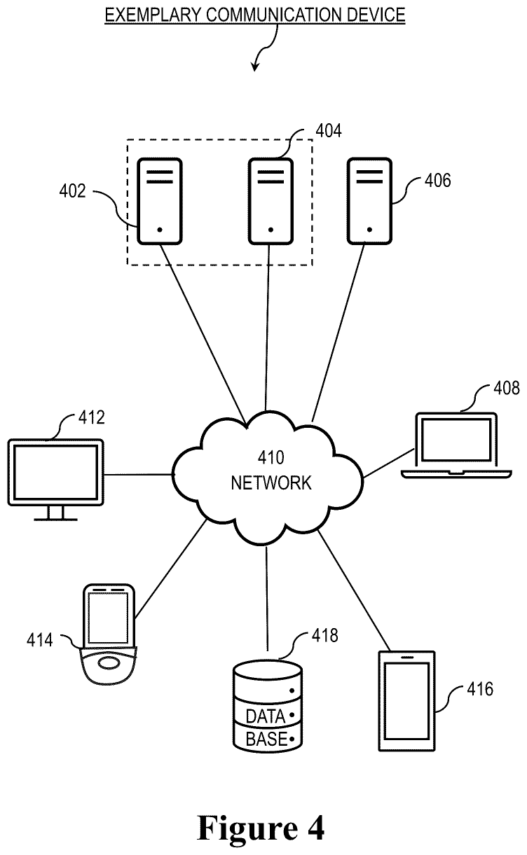

FIG. 4 is a diagram showing the web services of the platform and system. The platform and system are all components of an exemplary operating environment in which embodiments of the present invention may be implemented. The system can include one or more user computers, computing devices, or processing devices which can be used to operate a client, such as a dedicated application, web browser, etc. The user computers 408, 412 can be general purpose personal computers 408, 412 (including, merely by way of example, personal computers and/or laptop computers running a standard operating system), cell phones or PDAs 414, 416, (running mobile software and being Internet, e-mail, SMS, Blackberry, or other communication protocol enabled), and/or workstation, computers running any of a variety of commercially-available UNIX or UNIX-like operating systems (including without limitation, the variety of GNU/Linux operating systems). These user computers may also have any of a variety of applications, including one or more development systems, database client and/or server applications, and Web browser applications. Alternatively, the user computers may be any other electronic device, such as a thin-client computer, Internet-enabled gaming system, and/or personal messaging device, capable of communicating via a network 410 (e.g., the network described below) and/or displaying and navigating Web pages or other types of electronic documents. Although the exemplary system is shown with four user computers, any number of user computers may be supported.

In most embodiments, the system includes some type of network 410. The network 410 can be any type of network 410 familiar to those skilled in the art that can support data communications using any of a variety of commercially-available protocols, including without limitation TCP/IP, SNA, IPX, AppleTalk, and the like. Merely by way of example, the network can be a local area network (“LAN”), such as an Ethernet network, a Token-Ring network and/or the like; a wide-area network; a virtual network, including without limitation a virtual private network (“VPN”); the Internet; an intranet; and extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, WiMAX, WiFi, CDMA 2000, WCDMA, the Bluetooth protocol known in the art, and/or any other wireless protocol); and/or any combination of these and/or other networks.

The system may also include one or more server computers 402, 404, 406 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers may be dedicated to running applications, such as a business application, a Web server, application server, etc. Such servers may be used to process requests from user computers. The applications can also include any number of applications for controlling access to resources of the servers.

FIG. 4 further illustrates an environment where an on-demand distributed 418 service might be used. As illustrated in FIG. 4 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users access the on-demand database service via user systems, or third-party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level Thus, different users will have different permissions with regard to accessing and modifying application and database information, depending on a user's security or permission level.

A network can be a LAN (local area network), WAN (wide area network), wireless network, point-to-point network, star network, token ring network, hub network, or another appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all its components are operator configurable using applications, such as a browser, including computer code run using a central processing unit such as an Intel Pentium® processor or the like. Similarly, a computer system (and additional instances of an enterprise database, where more than one is present) and all their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), Microdrive, and magneto-optical disks, and magnetic or optical cards, nano systems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The Web server can be running an operating system 400 including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers. As one example, a server may execute one or more. Web applications. The Web application may be implemented as one or more scripts or programs written in any programming language, such as Java®, C, C#, or C++, and/or any scripting language, such as Perl, Python, or TCL, as well as combinations of any programming/scripting languages. The server(s) may also include database servers, including without limitation those commercially available from Oracle®, Microsoft®, Sybase®, IBM®, and the like, which can process requests from database clients running on a user computer.

End users, or users that are viewing and using the network platform, all contribute data to the cloud. A web service platform helps secure that data and maintain the service's functionalities. Only authorized users and entities can authorize or unauthorize content and monitor data stored within the web service. The platform's web services help maintain the operations of elements managed by the storage system.

The system may also include one or more databases 420. The database(s) may reside in a variety of locations. By way of example, a database 418 may reside on a storage medium local to (and/or resident in) one or more of the computers. Alternatively, it may be remote from any or all of the computers, and/or in communication (e.g., via the network) with one or more of these. In a particular set of embodiments, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, such as Oracle 10g, that is adapted to store, update, and retrieve data in response to SQL-formatted commands.

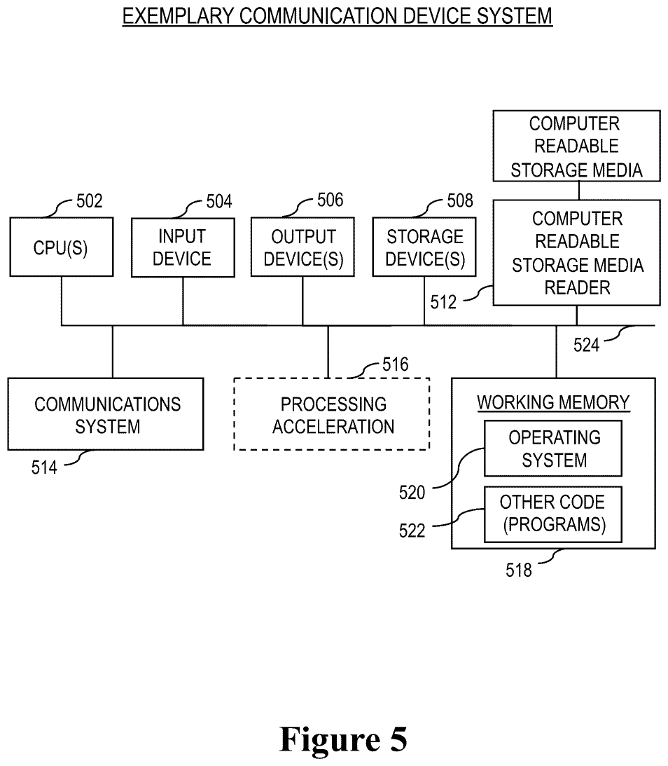

FIG. 5 illustrates an exemplary computer system, in which embodiments of the present invention may be implemented. The system 500 may be used to implement any of the computer systems described above. The computer system 500 is shown comprising hardware elements that may be electrically coupled via a bus. The hardware elements may include one or more central processing units 502 (CPUs), one or more input devices 504 (e.g., a mouse, a keyboard, etc.), and one or more output devices 506 (e.g., a display device, a printer, etc.). The computer system 500 may also include one or more storage devices 508. By way of example, the storage device(s) can include devices such as disk drives, optical storage devices, solid-state storage device such as a random-access memory (“RAM”) and/or a read-only memory (“ROM”), which can be programmable, flash-updateable and/or the like, as well as non-transitory and transitory storage mediums.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system may also include a processing acceleration unit 516, which can include a digital signal processor DSP, a special-purpose processor, and/or the like.

The computer-readable storage media reader 512 can further be connected to a computer-readable storage medium, together (and, optionally, in combination with storage device(s)) comprehensively representing remote, local, fixed, and/or removable storage devices plus storage media for temporarily and/or more permanently containing, storing, transmitting, and retrieving computer-readable information. The communications system may permit data to be exchanged with the network and/or any other computer described above with respect to the system.

The computer system may also comprise software elements, shown as being currently located within a working memory, including an operating system 520 and/or other code 522, such as an application program (which may be a client application, Web browser, mid-tier application, RDBMS, etc.). It should be appreciated that alternate embodiments of a computer system may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media 510 for containing code 522, or portions of code, can include any appropriate media known or used in the art, including storage media and communication media, such as but not limited to volatile and non volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

Although the disclosed technology is described above in terms of various exemplary embodiments and implementations, it should be understood that the various features, aspects, and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open-ended as opposed to limiting. As examples of the foregoing, the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for a backup near field communication wallet, said system comprising:
a network;
a plurality of near field communication devices in communication with a processing device;
a database in communication with said processing device;
a secret sharing algorithm employed on said processing device, wherein said one processing device comprises a central processing unit, a graphics processing unit, random access memory, and a machine-readable storage medium having instructions stored thereon/in which, when executed, cause said processing device to execute near field communication protocols comprising:
receiving user data to be stored on said plurality of near field communication devices via said processing device;
dividing said user data into a plurality of shares capable of being reconstituted when a threshold is met;
encrypting said user data and said plurality of shares;
transferring said plurality of shares to said plurality of near field communication devices such that one of said plurality of shares is transferred to one of said plurality of near field communication device;
storing one of said plurality of shares on said processing device;
uploading a backup of said user data to said database via a companion application stored on a foundation server.

2. The system of claim 1, wherein said secret sharing algorithm is a Shamir secret sharing algorithm.

3. The system of claim 1, wherein said shares are transferred via tapping one of said plurality of near field communication devices to said processing device.

4. The system of claim 1, wherein a password is created and used to gain access to said user data.

5. The system of claim 1, wherein said plurality of near field communication devices comprise wearable devices.

6. The system of claim 1, wherein radio frequency identification (RFID) is employed in each of said plurality of near field communication devices to enable location tracking.

7. The system of claim 1, wherein said backup of said user data is created habitually as a .txt file and encrypted by a seed hash, and wherein said foundation server uses a hash of said seed hash in place of a username to avoid unnecessary collection of personal data from said user.

8. A method for a backup near field communication wallet, said method comprising:
receiving user data to be stored on a plurality of near field communication devices via a processing device, and wherein a secret sharing algorithm is employed on said processing device;
dividing said user data into a plurality of shares capable of being reconstituted when a threshold is met via said secret sharing algorithm;
encrypting said user data and said plurality of shares;
transferring said plurality of shares to said plurality of near field communication devices such that one of said plurality of shares is transferred to one of said plurality of near field communication device;
storing one of said plurality of shares on said processing device;
uploading a backup of said user data to a database via a companion application stored on a foundation server, wherein said processing device, said plurality of near field communication devices, said database, and said foundation server are in communication via a network.

9. The method of claim 8, wherein said secret sharing algorithm is a Shamir secret sharing algorithm.

10. The method of claim 8, wherein said shares are transferred via tapping one of said plurality of near field communication devices to said processing device.

11. The method of claim 8, wherein a password is created and used to gain access to said user data.

12. The method of claim 8, wherein said plurality of near field communication devices comprise wearable devices.

13. The method of claim 8, wherein radio frequency identification (RFID) is employed in each of said plurality of near field communication devices to enable location tracking.

14. The method of claim 8, wherein said backup of said user data is created habitually as a .txt file and encrypted by a seed hash, and wherein said foundation server uses a hash of said seed hash in place of a username to avoid unnecessary collection of personal data from said user.

15. A system for a backup near field communication wallet, said system comprising:
a network;
a plurality of near field communication devices configured with location tracking and in communication with a processing device;
a database in communication with said processing device;
a Shamir secret sharing algorithm employed on said processing device, wherein said one processing device comprises a central processing unit, a graphics processing unit, random access memory, and a machine-readable storage medium having instructions stored thereon/in which, when executed, cause said processing device to execute near field communication protocols comprising:
receiving user data to be stored on said plurality of near field communication devices via said processing device;
dividing said user data into a plurality of shares capable of being reconstituted when a threshold is met;
encrypting said user data and said plurality of shares;
transferring said plurality of shares to said plurality of near field communication devices such that one of said plurality of shares is transferred to one of said plurality of near field communication device, and wherein said transferring is completed via tapping one of said plurality of near field devices to said processing device;
storing one of said plurality of shares on said processing device;
uploading a backup of said user data to said database via a companion application stored on a foundation server, wherein said backup of said user data is created habitually as a .txt file and encrypted by a seed hash, and wherein said foundation server uses a hash of said seed hash in place of a username to avoid unnecessary collection of personal data from said user.

16. The system of claim 15, wherein timestamps of each interaction, the number of shares, the number of unique IDs, and all interactions of near field communication with said processing device are stored in said database.

17. The system of claim 15, wherein said database is a cloud-based database.

18. The system of claim 15, wherein said machine-readable storage medium is a non-transitory storage medium.

19. The system of claim 15, wherein a password is created and used to gain access to said user data.

20. The system of claim 15, wherein said plurality of near field communication devices comprise wearable devices.
